(19) United States
(12) Patent Application Publication
(10) Pub. No.: US 2014/0085156 A1
(43) Pub. Date: Mar. 27, 2014

(54) TAPERED SLOT ANTENNA

(71) Applicants: Mussie Gebretnsae, Goeteborg (SE); Yvonne Jensen, Moelndal (SE); Elisabeth Stenquist, Moelnlycke (SE)

(72) Inventors: Mussie Gebretnsae, Goeteborg (SE); Yvonne Jensen, Moelndal (SE); Elisabeth Stenquist, Moelnlycke (SE)

(73) Assignee: SAAB AB, Linkoeping (SE)

(21) Appl. No.: 13/990,553

(22) PCT Filed: Dec. 20, 2010
(86) PCT No.: PCT/SE2010/051440

§ 371 Date: Jun. 17, 2013

(51) Int. Cl. H01Q 13/10

(52) U.S. Cl. CPC H01Q 13/10
USPC 343/767

(57) ABSTRACT

The tapered slot antenna element according to the invention comprises a tapered slot with a narrow inner part. The tapered slot antenna element further comprises a cavity for receiving a feeding probe. An inner wall of said is provided with a layer comprising an electric conductive material, and said cavity is provided with an open end. The cavity is adapted such that a feeding probe can be inserted into the cavity through the open end. The layer comprising the electric conductive material is adapted such that the coaxial field can be build up between the feeding probe and said layer of electric conductive material. Hence, said layer can be a homogenous layer or a wire netting or the like, as long as a coaxial field can be build up between the electric conductive layer and the feeding probe.

### TECHNICAL FIELD

The present invention relates to the field of antenna technology and especially a tapered slot antenna element, a feeding probe for a tapered slot antenna element and a tapered slot antenna arrangement.

### BACKGROUND ART

Tapered slot antennas are commonly known within the art. A tapered slot antenna is structured, such that a slot line radiates an electromagnetic wave directed parallel to the plane of the antenna. The slot line is commonly fed by a feeding line, which crosses the slot line. The feeding line is integrated in the tapered slot antenna and is connected to a circuit board. There are antennas in which the circuit board is integrated with the antenna element, these antennas have the antenna and the circuit board in the same plane, and thereby, connector means between the feeding line and the circuit board is not needed, since the feeding line can be etched directly on the circuit board.

However, in some applications it is whished that the antenna element is not in the same plane as the circuit board, whereby the antenna and the circuit board must be separated. There is further a demand to replace defect antenna elements or the circuit board without having to replace both of them. Thereby the antenna element and the circuit board must be connected with each other with connectors, such that the feeding line is properly contacted to the circuit board. Further, an attachment interface where the antenna element can be mounted must also be provided. The connector and the attachment interface obviously mean additional cost in both material and mounting time, especially in an antenna system comprising thousands of antenna elements. Thereby is there a need for an inexpensive and exchangeable antenna element.

### SUMMARY OF THE INVENTION

The present invention is defined by the appended independent claim. Various examples of the invention are set forth by the appended dependent claims as well as by the following description and the accompanying drawing.

Considering afore mentioned problems, the object of the present invention is to suggest an inexpensive and easy to mount tapered slot antenna.

The object is achieved through the inventive idea that a coaxial probe can be used as signal transition between the tapered slot antenna element and the circuit board. Thereby is the object of the invention achieved through a tapered slot antenna element according to claim 1, a feeding probe according to claim 6 and a tapered slot antenna arrangement according to claim 10.

The inventive idea is to create a coaxial field within the tapered slot antenna element. Said coaxial field crosses the slot line of the tapered slot, and which thereby can feed the tapered slot. Hence the feeding signal is fed into the slot line by the coaxial field. Due to this inventive design a connector between the tapered slot antenna element and the circuit board is not needed any more.

The tapered slot antenna element according to the invention comprises a tapered slot with a narrow inner part. The tapered slot can be any kind known in the art, i.e. a tapered notch, a stepped notch, vivaldi or a bunny ear. The type of tapered slot antenna does not influence the inventive idea, which just comprises the feeding of the tapered slot antenna and can be used with any antenna type.

The tapered slot antenna element further comprises a cavity for receiving a feeding probe. An inner wall of said cavity is provided with a layer comprising an electric conductive material, and said cavity is provided with an open end. The cavity is adapted such that a feeding probe can be inserted into the cavity through the open end. The layer comprising the electric conductive material is adapted such that the coaxial field can be build up between the feeding probe and said layer of electric conductive material. Hence, said layer can be a homogenous layer or a wire netting or the like, as long as a coaxial field can be build up between the electric conductive layer and the feeding probe.

The feeding probe comprises a conductive core and is adapted such, that when it is inserted into the cavity, the conductive core and the layer of electric conductive material is the inner wall of the cavity is distanced from each other. The coaxial field can thereby be build up in the space between the conductive core and said layer of electric conductive material in the inner wall of the cavity. The space between the conductive core and said layer of electric conductive material can be filled with air or a dielectric material. The tapered slot is arranged in the antenna element, such that it cuts the coaxial field, whereby the tapered slot can be fed by the coaxial field. Thereby a radio frequent signal can be fed into the tapered slot through the coaxial field. This is further explained in conjunction with FIG. 1.

The slot of the tapered slot antenna element is located such that when said conductive core is mounted in the cavity, it extends inside the cavity such that it at least reaches beyond the point where the slot line cuts the cavity. Thereby it is secured that the coaxial field reaches the slot line.

A preferred and effective shape for the cavity, the feeding probe and the conductive core is circular cylindrical, and wherein the conductive core is placed symmetrical within the cavity. With such a configuration it is possible to build up a homogenous and coaxial field between the conductive core and the layer comprising the conductive material, which is located on the inner wall. However, the inventive tapered slot antenna element, feeding probe and tapered slot antenna arrangement is not limited to a circular cylindrical configuration. As long as a coaxial field can be build up between the conductive core and the layer comprising electric conductive material in/on the inner wall of the cavity, the individual elements can have arbitrary shapes, and in any combination thereof.

The inventive tapered slot antenna element can be made of any material; however, it is important that the layer comprising the electric conductive material in/on the inner wall of the cavity is enabling a coaxial field to be build up between the inner wall and the conductive core of the feeding probe. The layer comprising the electric conductive material is preferably the outer layer of the inner wall.

Due to the inventive coaxial contact between the circuit board and the antenna element, it is possible to produce the whole tapered slot antenna element in one piece of material, as long as the material is electrically conductive. A tapered slot antenna element could for example be made in casted aluminium, iron or other suitable metal. However, a tapered slot antenna element according to the invention comprising a plurality of materials is just as possible, as long as a layer of electric conductive material is provided such that the coaxial field can be build up between said layer and a feeding probe located in the cavity of the antenna element. For example, a light weight antenna could be produced in a composite or a plastic material.

A tapered slot antenna is commonly used as a part of an array antenna, in which a plurality of tapered slot antennas is used. In such radars the direction of the individual antenna elements relative each other is important to secure a high performance of the array. To assure a correct positioning of the individual tapered slot antenna elements, it is suggested that each antenna element comprises one or a plurality of guides. The guides are adapted to direct the tapered slot antenna element into its correct and desired position. The guide is preferably located on the circuit board on which also the feeding probe is located. However, also the feeding probe can be used as a guide.

The feeding probe is located on the circuit board, from which it is fed. The feeding probe preferably comprises a dielectric coverage surrounding the conductive core. Said dielectric coverage is adapted to fit into said cavity, and at least partially fills the distance between the conductive core and the inner wall. However it is preferred that dielectric coverage is adapted to fit into the cavity of the tapered slot antenna element, such that it can support the tapered slot antenna element. The dielectric coverage of the feeding probe can be designed such that it tightly fits into the cavity, whereby the tight fit also functions as a fixation means of the tapered slot antenna element on the circuit board and there won't be any play between the tapered slot antenna element and the feeding probe.

The feeding probe is preferably but not necessary directed perpendicular from the plane of the circuit board, thereby providing an easy mounting of the tapered slot antenna element. However, alternative directions are also possible, i.e. up to 90.

In a system using an array of tapered slot antenna arrangements, the tapered slot antenna elements can be mounted in arrays or in rows, the inventive tapered slot antenna is suitable to use in any such configuration.

To protect the tapered slot antenna elements from any radiation from the electronic components on the circuit board, the antenna elements can be provided with one common ground plane, wherein said ground plane is mounted on the back of said tapered slot antenna elements.

In an alternative embodiment of the tapered slot antenna element, the before mentioned ground plane is made of the same piece of material as a plurality tapered slot antenna elements.

When the tapered slot antenna arrangement is used in a moving environment, such as an airplane or a ship, the tapered slot antenna elements has to be attached in their desired position. This can be made with any available means, such as with a snap fitting, by screwing or gluing.

### BRIEF DESCRIPTION OF THE DRAWINGS

The invention is hereinafter explained and described in conjunction with the enclosed drawings, on the basis of an embodiment of the invention from which further features and advantages of the invention can be out read.

FIG. 1 discloses a principle drawing of the inventive tapered notch antenna arrangement.

FIG. 2 discloses a schematic drawing of an inventive tapered notch antenna element.

FIG. 3 discloses a schematic drawing of a plurality of tapered notch antenna arrangements in a first embodiment.

FIG. 4 discloses a schematic drawing of a plurality of tapered notch antenna arrangements in a second embodiment.

### DETAILED DESCRIPTION

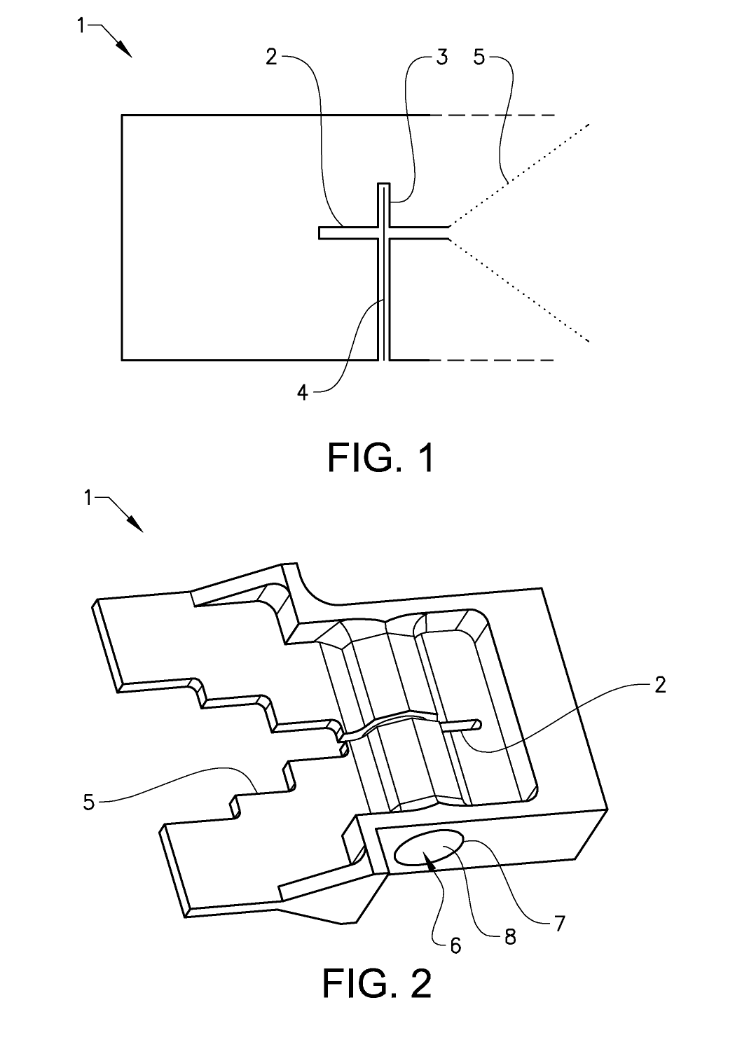

In FIG. 1 is a principle drawing of the principle of the invention disclosed. In the drawing the tapered slot antenna element 1, the slot line 2 and the layer 3 comprising conductive material surrounding the conductive core 4 are shown. Due to difference in potential between the conductive core 4 and the layer 3 a coaxial field is built up between these two elements 3, 4. A local maximum of the coaxial field is built up where the slot line 4 cuts the layer 3, whereby the coaxial field can feed the slot line 4. The signal fed into the slot line 4 is then transmitted through the slot line 4 and into the tapered notch 5.

In FIG. 2 an embodiment of an inventive tapered slot antenna element 1 is shown. The tapered slot antenna element 1 is provided with an aperture with a slot line 2. The aperture 5 is shown as a stepped slot, however other forms of slots is just as possible, e.g. tapered slot, Vivaldi, or bunny ear. The type of aperture 5 is not essential for the invention, which is compatible with all types of slot antennas.

In the embodiment shown in FIG. 2 the tapered slot antenna element 1 is made in one piece of material and is preferably an aluminium or aluminium alloy cast. The antenna element 1 can however be made using any suitable production method and/or one or several other materials, as long as it fulfils the features of claim 1. Hence, the tapered notch antenna element 1 in the embodiment is a mechanical antenna element without any electronic components. Due to the inventive idea is it possible to produce the whole antenna element 1 in one piece of material. Such a tapered notch antenna element is simple in its design, is relative light weight, robust and is easy and inexpensive to produce. Obviously the same inventive principle can be used with antenna elements comprising a plurality of materials.

Further the tapered slot antenna element 1 comprises a cavity 6, which has an opening 7, into which a conductive core 4 is to be inserted. The slot line 2 of the tapered notch 5 cuts the cavity 3, such that a RF-signal fed into the coaxial field between the conductive core 4 and the inner wall 8 of the cavity is fed into the slot line 2. Since the tapered slot antenna element 1 is made out of one piece of material, the layer comprising a conductive material is constituted by the inner wall 8 of the cavity 6.

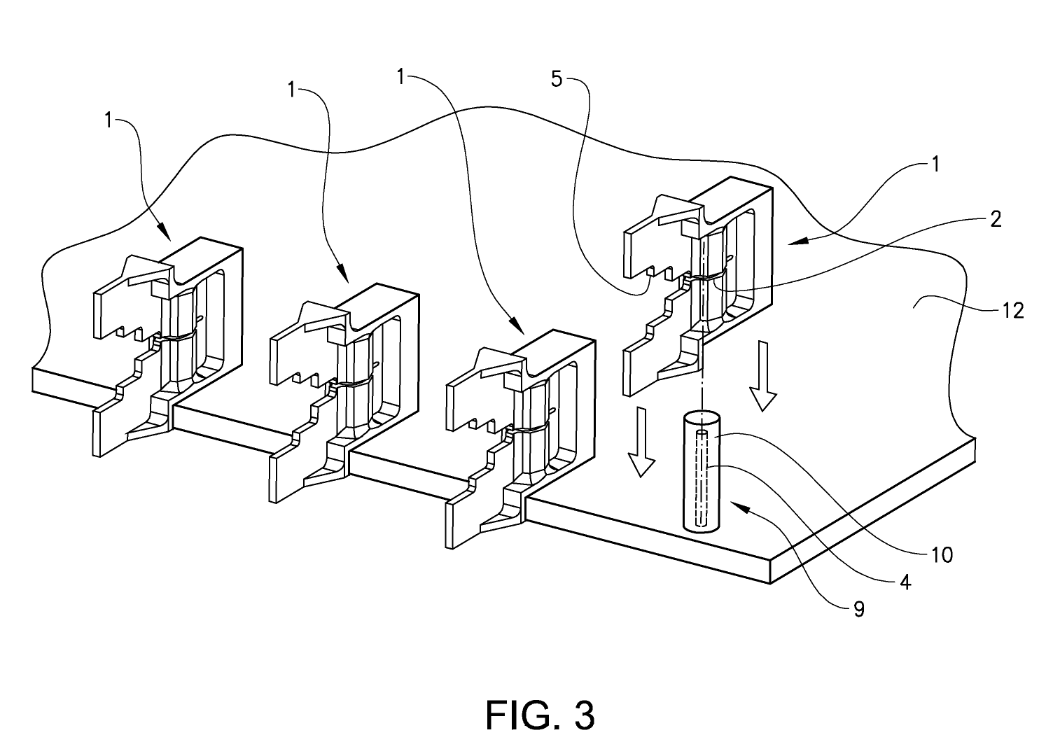

In FIG. 3 shows an illustration of how the tapered slot antenna element 1 is mounted on a feeding probe 9. Said feeding probe 9 is arranged on a circuit board 12. The tapered slot antenna element 1 is of the same type as shown in FIG. 1. The feeding probe 9 comprises the conductive core 4 and a dielectric coverage 10, which fits into the cavity 6 in the tapered notch antenna element 1. The dielectric coverage 10 around the conductive core 4 is adapted to fit tightly into the cavity 6, such that there is no play when the tapered slot antenna element 1 is arranged thereon.

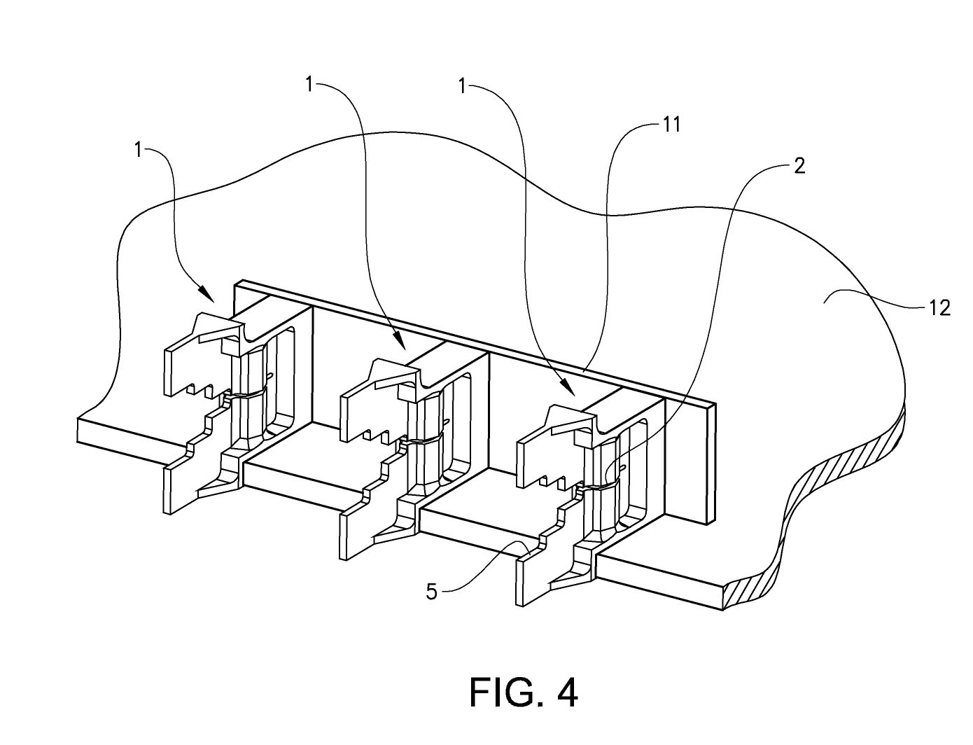

In FIG. 4 is an embodiment of a tapered slot antenna arrangement with a plurality of tapered slot antenna elements 1 sharing the same ground plane 11. The tapered slot antenna arrangements in FIG. 4 are mounted on a circuit board 12. The ground plane 11 is to protect the tapered slot antenna elements 1 from radiation from the electronic components on the circuit board. A common ground plane 11 made out of the same piece material as the tapered slot antenna elements 1 is advantageous, since the tapered slot antenna elements 1 and the ground plane 11 can be produced in the same process, for example through casting.

The invention is capable of modification in various obvious respects, all without departing from the scope of the appended claims. Accordingly, the drawing and the description thereto are to be regarded as illustrative in nature, and not restrictive.

1-15. (canceled)

16. Tapered slot antenna element (1), said element comprising:
a tapered slot (5) with a slot line (2) configured to receive a feeding signal, wherein:
said tapered slot antenna element (1) further comprises a cavity (6) for receiving a feeding probe (9);
an inner wall (8) of said cavity (6) is provided with a conductive layer (3);
said cavity (6) is provided with an open end (7) into which the feeding probe (9) can be inserted, such that a coaxial field can be build up between the feeding probe (9) and said layer (3); and
said slot line (2) of said tapered slot (5) cuts into said cavity (6), such that a signal fed into said coaxial field is fed into said tapered slot (5).

17. Tapered slot antenna element according to claim 16 wherein said tapered slot antenna element (1) is made out of one piece of material.

18. Tapered slot antenna element (1) according to claim 16, wherein said cavity (6) is cylindrical.

19. Tapered slot antenna element (1) according to claim 16, wherein said cavity (6) is at least one of circular, rectangular, or octagonal.

20. Tapered slot antenna element (1) according to claim 16, wherein:
said tapered slot antenna element (1) is provided with a guide at its lower edge; and
said guide is configured to guide the tapered slot antenna element (1) into a desired position.

21. Feeding probe (9) adapted for a tapered slot antenna element (1) according to claim 16, wherein:
the feeding probe (9) comprises a conductive core (4); and
the feeding probe (9) is configured to fit into the cavity (6) of said tapered slot antenna element (1), such that the conductive core (4) and the inner wall (8) of said cavity (6) are distanced to each other.

22. Feeding probe (9) according to claim 21, wherein said conductive core (4) is provided with a dielectric coverage (10).

23. Feeding probe according to claim 22, wherein said dielectric coverage (10) is configured to fit into said cavity (6), such that the dielectric coverage (10) at least partially fills the distance between the conductive core (4) and the inner wall (8).

24. Feeding probe according to claim 21, wherein the feeding probe (9) is directed 90 degrees from the surface of a circuit board (12).

25. Tapered slot antenna arrangement, comprising a tapered slot antenna element (1) according claim 16 and a feeding probe (9), wherein:
the feeding probe (9) comprises a conductive core (4);
the feeding probe (9) is configured to fit into the cavity (6) of said tapered slot antenna element (1), such that the conductive core (4) and the inner wall (8) of said cavity (6) are distanced to each other; and
the feeding probe (9) is further arranged inside the cavity (6) of the tapered slot antenna element (1), such that said conductive core (4) extends inside the cavity (6) such that it at least reaches beyond the point where the slot line (2) cuts the cavity (6).

26. Tapered slot antenna arrangement according to claim 25, wherein a plurality of tapered slot antenna arrangements are mounted in a row.

27. Tapered slot antenna arrangement according to claim 25, wherein a plurality of tapered slot antenna arrangements are mounted in arrays.

28. Tapered slot antenna arrangement according to claim 26, wherein said plurality of tapered slot antenna arrangements is provided with one common ground plane (11), wherein said ground plane (11) is mounted on the back of said tapered slot antenna elements (1).

29. Tapered slot antenna arrangement according to claim 27, wherein said plurality of tapered slot antenna arrangements is provided with one common ground plane (11), wherein said ground plane (11) is mounted on the back of said tapered slot antenna elements (1).

30. Tapered slot antenna arrangement according to claim 27, wherein said tapered slot antenna elements (1) in said tapered slot antenna arrangements are made of one piece of material.

31. Tapered slot antenna arrangement according to claim 25, wherein said feeding probe (9) is arranged on a circuit board (12) and said tapered slot antenna element (1) is configured to be snap fitted into a desired position on said circuit board (12).
